(19) United States
(12) Patent Application Publication
(10) Pub. No.: US 2026/0274675 A1
(43) Pub. Date: Sep. 17, 2026

(54) GRAPHENE AND METHODS OF MAKING GRAPHENE

(71) Applicant: University of Virginia Patent Foundation, Charlottesville, VA (US)

(72) Inventors: Xiaodong LI, Charlottesville, VA (US); Jiajun HE, Charlottesville, VA (US)

(21) Appl. No.: 18/873,910

(22) PCT Filed: Jun. 23, 2023
(86) PCT No.: PCT/US2023/068927

§ 371 Date: Dec. 11, 2024

Related U.S. Application Data
(60) Provisional application No. 63/355,404, filed on Jun. 24, 2022.

(51) Int. Cl. C01B 32/19; C01B 32/21; C01B 32/348

(52) U.S. Cl. CPC C01B 32/19; C01B 32/21; C01B 32/348; C01B 2204/02; C01B 2204/04; C01B 2204/32; C01P 2006/12

(57) ABSTRACT

The present disclosure provides for methods of making graphene, systems for making graphene and graphene produced from the methods and systems. Biomass materials, such as cotton materials, can be converted to graphite and then the graphite is converted into graphene. One method of the present disclosure can include removing substances from the biomass material, carbonization, graphitization, and exfoliation.

### CROSS-REFERENCE TO RELATED APPLICATION

This application claims priority to U.S. provisional application entitled “Hydrogen Passivation Aided Conversion of Cotton to High-Quality Graphene” having Ser. No. 63/355,404 filed on Jun. 24, 2022, which is entirely incorporated herein by reference. Hydrogen Passivation Aided Conversion of Cotton to High-Quality Graphene.

### FEDERAL SPONSORSHIP

This invention was made with government support under 1728042 awarded by the National Science Foundation. The government has certain rights in the invention.

### BACKGROUND

Graphene has attracted wide attention since the last century due to the outstanding properties and vast application potential in various fields. However, the large-scale fabrication of high-quality well-dispersed graphene is still challenging on aspects of raw material and manufacturing process.

### SUMMARY

Embodiments of the present disclosure provide for methods of making graphene, systems for making graphene and graphene produced from the methods and systems. In general, biomass materials, such as cotton materials, can be converted to graphite and then the graphite is converted into graphene. In general, a method of the present disclosure can include removing substances (e.g., proteins, sugar, ash, and organic compounds) from the biomass material, carbonization, graphitization, and exfoliation.

In an aspect, the present disclosure provides for methods of making graphene, comprising: providing a biomass material, wherein the biomass material comprising cellulose-based fibers; exposing the biomass material to an activating agent to form a treated biomass material; carbonizing the treated biomass material in a furnace at a temperature of about 400 to 1200° C. for about 0.5 to 4 hours to form carbonized biomass material; graphitizing, after carbonizing, the carbonized biomass material in the furnace at about 1000 to 3000° C. for about 0.5 to 3 hours to form graphite; shear mixing the graphite with optional hydrogen passivation of the graphite; and ultrasonication, after shear mixing or simultaneously, of the graphite, with optional hydrogen passivation of the graphite, to form graphene.

In an aspect, the present disclosure provides for methods of making graphene, comprising: providing a biomass material, wherein the biomass material comprising cellulose-based fibers; exposing the biomass material to an activating agent to form a treated biomass material, optionally wherein the activating agent disrupts interlayer interactions within the biomass material; carbonizing the treated biomass material in a furnace at a temperature of about 500 to 1000° C. for about 0.5 to 4 hours to form carbonized biomass material; graphitizing, after carbonizing, the carbonized biomass material in the furnace at about 1100 to 2200° C. for about 0.5 to 3 hours to form graphite; shear mixing the graphite with concurrent hydrogen passivation of the graphite; and ultrasonication, after shear mixing or simultaneously, of the graphite, with concurrent hydrogen passivation of the graphite, to form graphene.

In an aspect, the present disclosure provides for methods of making graphene, comprising: providing a cotton material, wherein the cotton material comprising cellulose-based fibers; exposing the cotton material to an activating agent to form a treated cotton material; carbonizing the treated cotton material in a furnace at a temperature of about 600 to 900° C. for about 0.5 to 4 hours to form carbonized cotton material; graphitizing, after carbonizing, the carbonized cotton material in the furnace at about 1000 to 1200° C. for about 1 to 3 hours to form graphite; shear mixing the graphite with concurrent hydrogen passivation of the graphite; and ultrasonication of the graphite with concurrent hydrogen passivation of the graphite, to form graphene, wherein a total time of shear mixing and ultrasonication is about 1 to 12 hours.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1J illustrate the characterization of cotton-derived graphene. FIG. 1A is a schematic illustration of producing graphene from cotton. FIG. 1B illustrates a TEM image of cotton-derived graphite. FIG. 1C illustrates a HRTEM image of cotton-derived graphite, where the inset is the corresponding FFT pattern. FIG. 1D illustrates a Raman spectrum of cotton-derived graphite. FIG. 1E illustrates a TEM image of cotton-derived graphene. FIG. 1F illustrates a HRTEM image of cotton-derived graphene. FIG. 1G illustrates a convoluted lattice image of cotton-derived graphene, where the inset is the corresponding FFT pattern.

FIG. 1H illustrates an AFM image of cotton-derived graphene. FIG. 1I illustrates a cross-sectional height profile of the graphene indicated by the yellow line. FIG. 1J illustrates a Raman spectrum of cotton-derived graphene.

FIGS. 2A-2G illustrate MD simulation of the shear exfoliation of pristine graphene. FIG. 2A illustrates schematics of the shear exfoliation of graphene (Red: Carbon, Blue: Oxygen, Green: Hydrogen). FIGS. 2B-2G illustrate snapshots of graphene exfoliation process at T=0, 25, 50, 75, 100, and 115 Ps.

FIGS. 3A-3B illustrate H₂ adsorption on graphene. FIG. 3A illustrates an energy profile of H₂ adsorption on the zigzag and armchair edge. FIG. 3B illustrates an energy profile of H₂ adsorption on flat and deformed graphene surface.

FIGS. 4A-4C illustrate a comparison of shear exfoliation of pristine and H-passivated graphene. FIG. 4A illustrates a shear distance vs time for pristine and H-passivated graphene.

FIG. 4B illustrates a pair potential energy of pristine and H-passivated graphene during shear exfoliation. FIG. 4C illustrates an interlayer interaction energy of pristine and H-passivated graphene during shear exfoliation.

FIG. 5 illustrates digital images of graphene dispersion captured at 0 h, 12 h, 18 h, 24 h, and 48 h.

FIGS. 6A-6C illustrate an interlayer force of flat graphene during shear exfoliation. FIG. 6A illustrates a schematic illustration of a two-layer flat graphene. FIG. 6B illustrates an interlayer force in the X direction during shear exfoliation. FIG. 6C illustrates an interlayer force in the Y direction during shear exfoliation.

FIGS. 7A-7B illustrate schematics of H₂ adsorption on graphene edge. FIG. 7A illustrates H₂ adsorption on the zig-zag edge. FIG. 7B illustrates H₂ adsorption on the armchair edge (Red: Carbon, Yellow: Hydrogen).

FIGS. 8A-8B illustrate schematics of H₂ adsorption on graphene surface. FIG. 8A illustrates H₂ adsorption on flat surface. FIG. 8B illustrates H₂ adsorption on deformed surface (Red: Carbon, Yellow: Hydrogen).

FIGS. 9A-9E illustrate MD simulation of the shear exfoliation of H-passivated graphene. FIGS. 9A-9E are snapshots of graphene exfoliation process at T=0, 25, 50, 75, and 85 Ps (Red: Carbon, Blue: Oxygen, Green: Hydrogen Yellow: Hydrogen).

FIGS. 10A-10B illustrate the equilibrium state of graphene in water. FIG. 10A illustrates pristine graphene in water. FIG. 10B illustrates H-passivated graphene in water (Red: Carbon, Blue: Oxygen, Green: Hydrogen, Yellow: Hydrogen).

FIGS. 11A-11B illustrate the agglomeration of isolated graphene. FIG. 11A illustrates the initial position of separated graphene. FIG. 11B illustrates the agglomerated graphene.

FIGS. 12A-12E illustrate MD simulation of the agglomeration of pristine graphene. FIGS. 12A-12E illustrate snapshots of pristine graphene in water at T=0, 50, 100, 150, and 200 Ps (Red: Carbon, Blue: Oxygen, Green: Hydrogen).

FIGS. 13A-13E illustrate MD simulation of the agglomeration of H-passivated graphene. FIGS. 13A-13E are snapshots of H-passivated graphene in water at T=0, 50, 100, 150, and 200 Ps (Red: Carbon, Blue: Oxygen, Green: Hydrogen Yellow: Hydrogen).

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, inorganic chemistry, material science, physics, and the like, which are within the skill of the art. Such techniques are explained fully in the literature.

The following description and examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar or psig. Standard temperature and pressure are defined as 25° C. and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequences where this is logically possible. Different stereochemistry is also possible, such as products of cis or trans orientation around a carbon-carbon double bond or syn or anti addition could be both possible even if only one is drawn in an embodiment.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the terms “optional” or “optionally” means that the subsequently described event or circumstance can or cannot occur, and that the description includes instances where said event or circumstance occurs and instances where it does not.

### Definitions

“Biomass” can include as-products, by-products, and/or residues of the textile, forestry, and agriculture industries. Biomass includes, but is not limited to, algae, plants, trees, crops, crop residues, grasses, forest and mill residues, saw dust, wood and wood wastes, fast-growing trees, and combinations thereof. In addition, biomass can include waste products from textile production (e.g., materials not used in the end textile product like cuttings, rejected products, excess material that is not going to be used, and the like), textile products (e.g., shirts, pants, undergarments, and the like), and textile products that are intended to be recycled (e.g., shirts, pants, undergarments, and the like that have run their lifespan for a user). In particular, biomass can include cotton materials such as textile products made of cotton (e.g., cotton textile), cotton waste material produced during the production of the cotton textile product, and cotton textiles that are intended to be recycled. Further biomass can include cotton fibers, bamboo fibers, wood fibers, leaf fibers, straw fibers, produced fibers, and fruit peels (e.g., banana peels and citrus peels). In a particular aspect, the biomass comprises cellulose-based fibers (e.g., cellulose fibers). Biomass may include various combinations of all of the specific biomass materials described herein.

The term “cotton textile” refers to a textile fabric composed of cotton fibers or other cellulose-based fibers.

### General Discussion

The present disclosure provides for methods of making graphene, systems for making graphene and graphene produced from the methods and systems. In general, biomass materials, such as cotton materials, can be converted to graphite and then the graphite is converted into graphene. The present disclosure provides for a cost-effective strategy for deriving high-quality graphene from biomass (e.g., cotton). In general, a method of the present disclosure can include removing substances (e.g., proteins, sugar, ash, and organic compounds) from the biomass material, with the exception of cellulose fibers and weakening the hydrogen bonds and van der Waals force between the cellulose fibers while also keeping their layered structures. The method next produces graphene using graphitization and exfoliation. The graphene produced using methods of the present disclosure exhibit intact structure with no obvious defect, and high dispersion in water after long-standing (e.g., 2 to 5 days), enabling the transformation rate of graphite to graphene to reach almost 100% (e.g., about 80% or more, about 90% or more, about 95% or more, or about 99% or more), and significantly improving the productivity of biomass-derived graphene. Additional details are provided in Example 1.

In a particular aspect, the biomass material can be a cotton material. Methods of the present disclosure can produce high-quality graphene from cotton via the methods described herein. In short, cotton materials are composed of multi-layered cellulose fibers bonded with various organic substances, such as protein, sugar, ash, and organic acids. Activation using an activating agent, such as a base, including alkali (e.g., KOH, NaOH or the like), acid (e.g., H₃PO₄, H₂SO₄ or the like), or a salt (e.g., ZnCl₂, FeCl₃ or the like), before graphitization can effectively remove these substances while keeping the layered cellulose fiber and weakening the bonding between layers. The treated cotton material can be subject to a graphitization process to produce cotton graphite, which can then be exfoliated into graphene via shear mixing (e.g., hydrogen (H₂) passivation aided shear mixing) and sonication (e.g., hydrogen passivation aided ultrasonication). During the physical exfoliation, the insertion of hydrogen can help the formation of C—H bonds with the dangling carbon atoms in graphene, which can be used to avoid the agglomeration of graphene if desired. The graphene produced from the cotton material exhibits an intact structure and high dispersion in water after long-standing, enabling the transformation rate of graphite to graphene to reach about 80% or more, about 90% or more, about 95% or more, or about 99% or more and significantly improve the productivity of cotton-derived graphene.

Cotton material is a promising raw material for graphene fabrication due to its high sustainability, low cost, incredible structure, and feasible chemical composition. The biomass material can be a cotton material such as textile products made of cotton (e.g., cotton textile), cotton waste material produced during the production of the cotton textile product (e.g., selvage, cotton fabric remnants from the cutting floor), cotton textiles that are intended to be recycled, recycled cotton textiles, cotton straw, and other textiles and textile materials that include cotton fibers. The cotton material includes cellulose-based fibers (e.g., cellulose fibers).

Now having described aspects of the present disclosure generally, additional details are provided. The present disclosure provides for methods of making graphene using a biomass material, where the biomass material includes cellulose fibers. The biomass material can be exposed (e.g., mixed) with an activating agent (e.g., a base) to form a treated biomass material. Prior to introduction of the activating agent, the biomass material can be dispersed in an aqueous solution. The activating agent can be a base such as an alkali (e.g., KOH, NaOH or the like), an acid (e.g., H₃PO₄, H₂SO₄ or the like), or a salt (e.g., ZnCl₂, FeCl₃ or the like). The activating agent can be at a concentration range of about 0.1 M to 2 M. For example, the concentration of the base can be about 0.1 M to 2 M. The amount of activating agent added to the biomass material can depend upon the amount of biomass, the amount of aqueous solution, the type of biomass, and the like. In general, the amount of the activating agent can be about 5% to 30% of the mass of the biomass. The activating agent can be used to remove unwanted organic substances while not harming the cellulose fiber (optionally maintaining the layered cellulose fiber) and weakening the bonding between layers among the cellulose fibers. After treatment with the activating agent, the treated biomass material can be rinsed and dried. For example, the treated biomass material can be rinsed with distilled water and dried in an oven, where the temperature in the oven can be about 40 to 80° C. or about 60° C. for about 2 to 10 hours or 3 to 5 hours.

After treatment with the activating agent, the treated biomass material is carbonized. The treated biomass material can be positioned in a furnace and the temperature of the furnace can be about 400 to 1200° C. or about 700 to 800° C. for about 0.5 to 4 hours or about 1.5 to 2.5 hours to form carbonized biomass material. The furnace can be any high temperature furnace, such as the MTI GSL-1700X Series Tube Furnace.

After carbonization, the temperature of the furnace can be increased to graphitize biomass material. The temperature of the furnace can be about 1000 to 3000° C., about 1100 to 2000° C., about 1100 to 1300° C., or about 1200° C. The time frame for being in the furnace can be about 0.5 to 3 hours or about 1.5 to 2.5 hours, or about 2 hours to form graphite.

Subsequently, the graphite can be changed to graphene using shear mixing and sonication (e.g., ultrasonication). The graphite can be mixed with water to form a dispersion and subjected to shear mixing. The shear mixing can be performed using a rotary lab high shear mixer (e.g., L5M-A Shear Mixer) at about 3200 to 3800 rpm or higher speed up to 7200 rpm. Optionally, during the shear mixing, the dispersion is subjected to hydrogen passivation. Hydrogen passivation can be performed by pumping H₂ into the water at a rate of about 1 L/h to 20 L/h or about 1 L/h to 10 L/h or about 1 L/h to 2 L/h. The H₂ can be purchased or generated during the process. The shear mixing (and optionally with the hydrogen passivation) can be performed for about 0.5 to 10 hours, about 3 to 8 hours, or about 6 hours.

After the shear mixing or concurrent with the shear mixing, the graphene can be subjected to ultrasonication and optionally subjected to hydrogen passivation. The ultrasonication can be performed using common ultrasonic bath sonicator (e.g., Bransonic Ultrasonic Baths) that can generate sound waves having a frequency of about 20 kHz to about 350 kHz or higher frequency and/or sound waves having a power of about 80 watts to about 1,100 watts or higher power. Hydrogen passivation can be performed by pumping H₂ into the water at a rate of about 1 L/h to 20 L/h or about 1 L/h to 10 L/h or about 1 L/h to 2 L/h. The H₂ can be purchased or generated during the process. The sonication (and optionally with the hydrogen passivation) can be performed for about 0.5 to 3 hours, about 1.5 to 2.5 hours, or about 2 hours.

The shear mixing and ultrasonication (one or both optionally with the hydrogen passivation) convert the graphite to graphene. The shear mixing and ultrasonication can support the insertion of hydrogen to form C—H bonds with the dangling carbon atoms in graphene, which avoided the agglomeration of graphene. The total time of the shear mixing (and optionally with the hydrogen passivation) and ultrasonication can be about 0.5 to 12 hours or about 4 to 10 hours, or about 6 to 8 hours.

In an aspect, the shear mixing and ultrasonication are performed sequentially. In another aspect, the shear mixing and ultrasonication are performed simultaneously. In an aspect, the shear mixing includes hydrogen passivation. In an aspect, the ultrasonication includes hydrogen passivation. In an aspect, both shear mixing and ultrasonication include hydrogen passivation.

The transformation rate of graphite to graphene can be about 80% or more, about 90% or more, about 95% or more, or about 99% or more. The graphene can include a single layer, two layers, or three layers. In another aspect, the graphene can include four or more layers. A single layer graphene sheet can have a thickness of about 0.30 and 0.40 nm. The graphene has a specific surface area of about 1100 to 1400 m²·g⁻¹. Obtained graphene sheets have a large size of several hundred nanometers, and the graphene exhibits no obvious defects or impurities on the surface.

In a particular aspect, the biomass can be a cotton material, such as described herein. The method can include exposing the cotton material to an activating agent to form a treated cotton material. The treated cotton material is then carbonized in a furnace at a temperature of about 400 to 1200° C. or about 700 to 800° C. for about 0.5 to 4 hours or about 1.5 to 2.5 hours to form a carbonized cotton material. The carbonized cotton material can be graphitized in the furnace at about 1000 to 3000° C., about 1100-2000° C. or about 1150 to 1250° C., where the time in the furnace can be about 0.5 to 4 hours or about 1.5 to 2.5 hours to form graphite. The graphite can be shear mixed (and optionally subjected to hydrogen passivation) and sonicated (and optionally subjected to hydrogen passivation) (shear mixing and sonication can be performed stepwise or concurrently) to form graphene. Prior to carbonizing the treated cotton material, the treated cotton material can be dried for about 2 to 8 hours in an oven at a temperature of about 50 to 70° C. The shear mixing with concurrent hydrogen passivation is performed for about 0.5 to 10 hours or about 5 to 7 hours. The ultrasonication with concurrent hydrogen passivation is performed for about 0.5 to 3 hours. The shear mixing with concurrent hydrogen passivation and the ultrasonication with concurrent hydrogen passivation together are performed for about 0.5 to 12 hours, 4 to 10 hours or 6 to 8 hours. Conditions described in the regard to the methods using the biomass can also apply to the methods using the cotton material. Additional details regarding the methods using cotton are described in Example 1.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

Graphene, a single layer of well-aligned carbon atoms, is one of the most value-added carbon nanomaterials.¹⁻³ The impeccable structure endows graphene with outstanding thermal, electrical, and mechanical properties, attracting massive attention to its fabrication and application.⁴⁻⁹ Currently, the main methods for graphene fabrication include chemical vapor deposition (CVD), the Hummers method, and shear mixing. 10-12 The CVD method synthesizes graphene on particular substrates, providing a high yield of large and intact graphene.¹³ However, it suffers from high cost and low sustainability led by using fossil fuels as raw materials. 14, 15 Moreover, CVD-derived graphene is difficult to be removed from the substrates, which limits its further application.^{16, 17} As a promising alternative method of CVD, the Hummers method oxidizes graphite into graphene oxide (GO) by strong oxidation agents. GO is essentially monolayer graphene modified by various oxygen-containing functional groups, which endows GO with remarkable properties. Besides, GO can also be reduced to pristine graphene.^{18, 19} However, this method inevitably damages the crystal structure of graphene and reduces its mechanical strength.²⁰ The shear mixing method was developed to improve the productivity and efficiency of graphene fabrication while keeping the crystal structure.²¹ This method achieves low-cost graphene fabrication via a mechanical process without applying expensive chemical agents or relying on harsh reaction conditions.²² However, some issues need to be resolved before it meets the requirement of industrial applications. At first, the graphene sheets derived by shear mixing are likely to be agglomerated unless being stored in organic solvents or alkane.^{23, 24} On the other hand, the shear mixing method (as well as Hummers method) requires nonrenewable mined graphite as the raw material, leading to low sustainability as well as some environmental issues. Hence, exploring feasible raw materials for graphene fabrication and resolving graphene agglomeration is highly required to achieve the large-scale application of shear mixing.

Introducing biomass as the raw material to produce graphene has been widely reported to enhance the sustainability of graphene production.²⁵⁻²⁷ Biomass materials are often cost-effective, renewable, and of high carbon reserve, which satisfies the demand for large-scale graphene manufacture. Over the past decades, multiple biomass materials have been investigated for graphene production,²⁸⁻³³ and cotton has been found as one of the most promising raw materials due to its well-aligned structure and feasible chemical composition.³⁴⁻³⁶ However, it is still challenging to obtain biomass-derived single-layer graphene.^{37, 38} On the other hand, new rational strategies have also been proposed to improve graphene fabrication technology. For example, Yang et al. proposed a promising idea to avoid graphene agglomeration. More specifically, they reported that hydrogen passivation could effectively avoid agglomeration of mechanically exfoliated graphene in ethanol.³⁹ However, it is still unknown how hydrogen affects graphene agglomeration. Moreover, it also emerges a question: If hydrogen passivation could avoid graphene agglomeration, can it accelerate the mechanical exfoliation of graphite?

This Example describes the successful production of single-layer graphene from cotton by pyrolysis, hydrogen passivation (HP)-coupled shear mixing, and HP-coupled ultra-sonication. Cotton was verified as an ideal raw material for graphene fabrication due to its layered structure and chemical composition. The derived graphene has a large size, intact crystal structure, and distinguished dispersion in water. On the other hand, molecular dynamics (MD) simulation was employed to understand graphite exfoliation and graphene agglomeration. The effects of hydrogen passivation on exfoliation and agglomeration were detailly discussed.

### Experimental Section

### Graphitization of Activated Cotton

Five cotton sheets of 1.5 cm×5 cm were cut from a pure cotton T-shirt and then activated in 20 mL of 1 M KOH solution for 5 minutes. After drying at 60° C., the KOH-activated cotton sheets were heated first at 750° C. for 2 h and then at 1200° C. for 2 h to obtain graphite. The cotton-derived graphite was washed with deionized (DI) water to remove impurities and then dried for further use.

### Hydrogen Passivation Coupled Fabrication of Graphene

2.5 g cotton-derived graphite was ground into powders and dispersed in 200 mL DI water to form cotton-derived graphite suspension. The suspension was then conducted with shear mixing with a speed of 3,600 rpm for 6 h, followed by ultra-sonication for 2 h. Hydrogen gas was continuously inserted into the cotton graphite suspension during the shear mixing and ultra-sonication processes. The hydrogen gas was produced by a reaction between aluminum foils and 1 M HCl solution.

### Characterization of Materials

The cotton-derived graphite was first characterized by transmission electron microscopy (TEM; FEI Titan) and high-resolution transmission electron microscopy (HRTEM; FEI Titan). The TEM and HRTEM were also used to analyze cotton-derived graphene produced via HP-coupled shear mixing and ultra-sonication. Atomic force microscopy (AFM; Bruker) was used to explore monolayer graphene sheets from cotton-derived graphene. Raman spectroscopy (Renishaw Invia Raman microscope with the laser at 514 nm) was applied to determine the average thickness of cotton-derived graphene sheets.

### MD Simulation

All MD simulations were conducted by the Large-scale Atomic/Molecular Massively Parallel Simulator (LAMMPS).40 The initial configurations for modeling graphene exfoliation consists of a 2-layer graphene constructed via the Visual Molecular Dynamics (VMD) software.⁴¹ The intra-layer C—C interaction of graphene was modeled by the Morse-style bond and quartic-style angle.⁴² Meanwhile, the Adaptive Intermolecular Reactive Empirical Bond Order (AIREBO) potential was used to model graphene interlayer interaction.⁴² The graphene was inserted into water molecules described via the TIP4P/2005 model.⁴³ In addition, the SHAKE algorithm was used to fix the structure of water molecules. The size of the cell was set as 7 nm×18 nm×7 nm with periodic boundaries set in the three orthogonal directions. Graphene-water interaction was described by the simple Lennard-Jones potential.⁴⁴ The Morse style was used to model the C—H bond with coefficients of K=3.85 eV, r₀=1.1 Å. The LJ potential was employed to model the non-bond interactions of H₂O—H and graphene-H.^{45, 46} Nose-Hoover temperature thermostat (NVT) was performed with a time step of 1 fs to control the temperature at 300 K.

### Results and Discussion

### Fabrication and Characterization of Cotton-Derived Graphene

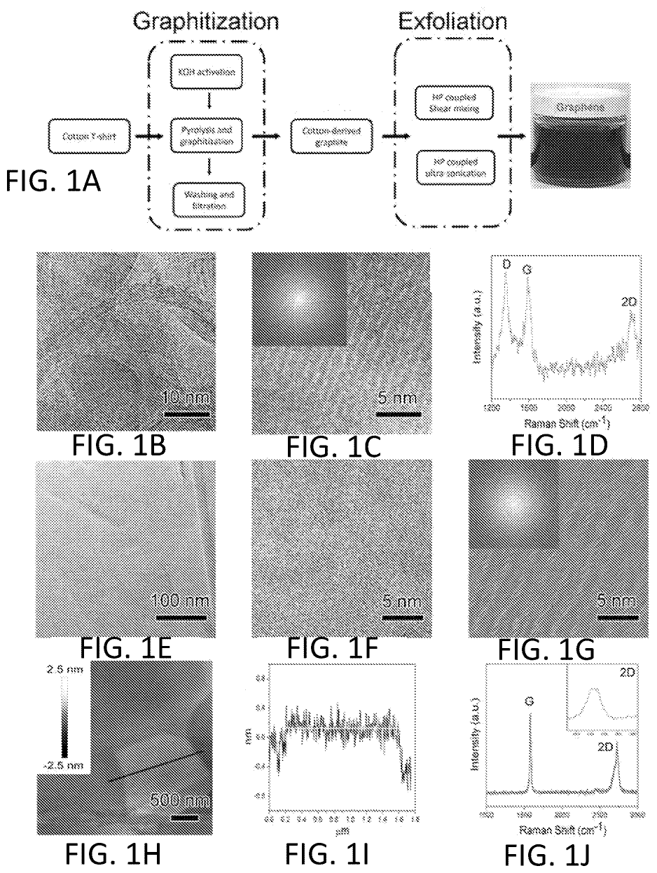

As illustrated in FIG. 1A, the conversion of cotton to graphene follows the route of graphitization and exfoliation. Cotton is a type of natural fiber composed of layered cellulose fibers, where the interlayer consists of various organic substances, such as protein, sugar, ash, and organic acids.⁴⁷ KOH activation would not damage the layered cellulose fiber. In the meantime, it could remove the interlayer substances and weaken the interlayer interaction. Then, the product of graphitization was analyzed via HRTEM, where it was found as polycrystalline with a well-aligned layered structure (FIGS. 1B, 1C). Further analysis via Raman (FIG. 1D) demonstrated the high crystallinity of cotton-derived graphite by the high peak of the G band (~1600 cm⁻¹) in the Raman spectrum. Moreover, the intensity of the G peak was twice the intensity of the 2D peak, proving the graphitization of cotton.⁴⁸ On the other hand, the high peak of the D band (~1350 cm⁻¹) in the Raman spectrum suggested apparent disorders and defects in derived graphite, which should be attributed to the random distribution of catalysts for graphitization. As known, cotton is rich in various metallic elements, including K, Ca, Mg, Fe, Cu, Mn, and Zn.⁴⁹ The minerals in cotton were reduced and functioned as the nuclei to catalyze the crystallization of surrounding carbon atoms, enabling graphitization at a relatively low temperature (1200° C.). Moreover, these minerals are simple to be removed for further processing.

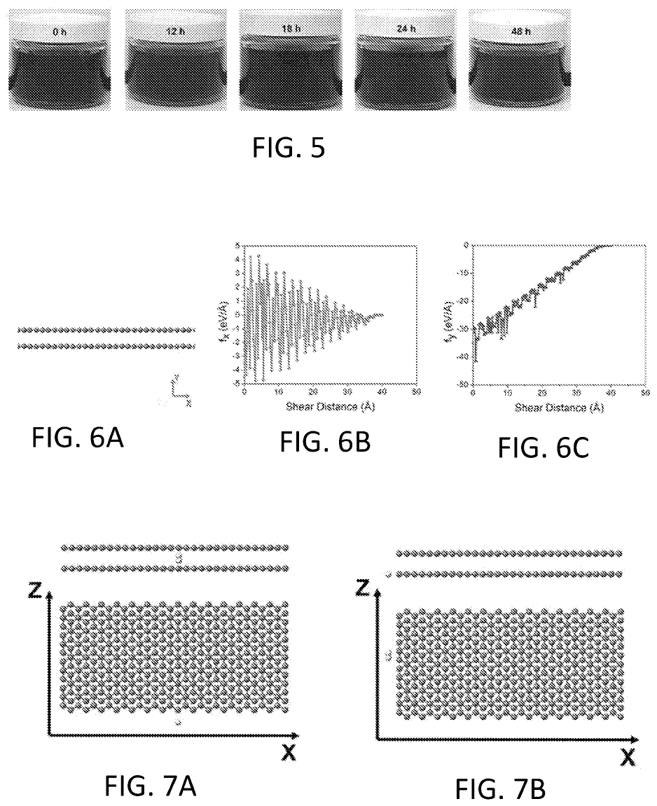

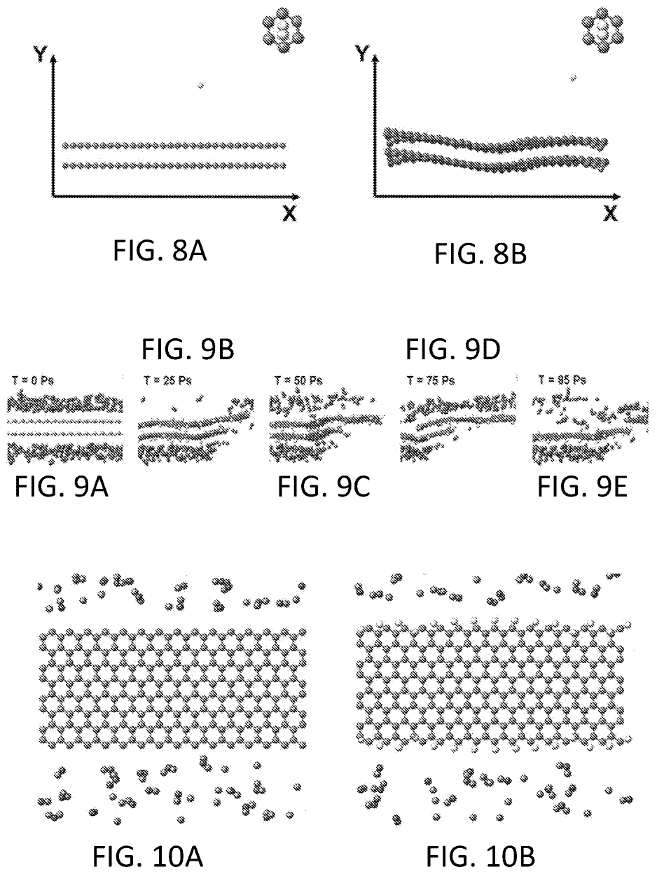

After graphitization, HP-coupled shear mixing and ultra-sonication were conducted to produce highly dispersive graphene from cotton-derived graphite. Consequently, ultra-thin graphene sheets with sizes of several hundred nanometers were obtained (FIG. 1E). The HRTEM image (FIG. 1F) illustrated the intact crystal of cotton-derived graphene, validated by the FFT and reversed FFT analysis (FIG. 1G). A piece of graphene sheet with a height of ~0.35 nm was found via AFM (FIGS. 1H, 1I), showing that this method successfully exfoliated single-layer graphene from cotton-derived graphite. The Raman spectrum also illustrated the big difference made by the exfoliation process (FIG. 1J). The 2D band showed significant change compared with the 2D peak of cotton-derived graphite, where the 2D peak was composed of two close peaks with similar intensity (FIG. 1J). Referring to the Raman spectrum of graphene with different layers,⁵¹ the products were mainly 2-layer and 3-layer graphene sheets. According to the layer number and AFM height profile, the specific surface area of cotton-derived graphene was approximated to be ~1260 m²·g⁻¹. Moreover, the graphene derived via this method was highly dispersive in water even after 48 h without obvious agglomeration (FIG. 5), which meant an almost 100% transfer rate from cotton-derived graphite.

### Theoretical Investigation of Shear Mixing H₂ Molecule Effects on Shear Exfoliation

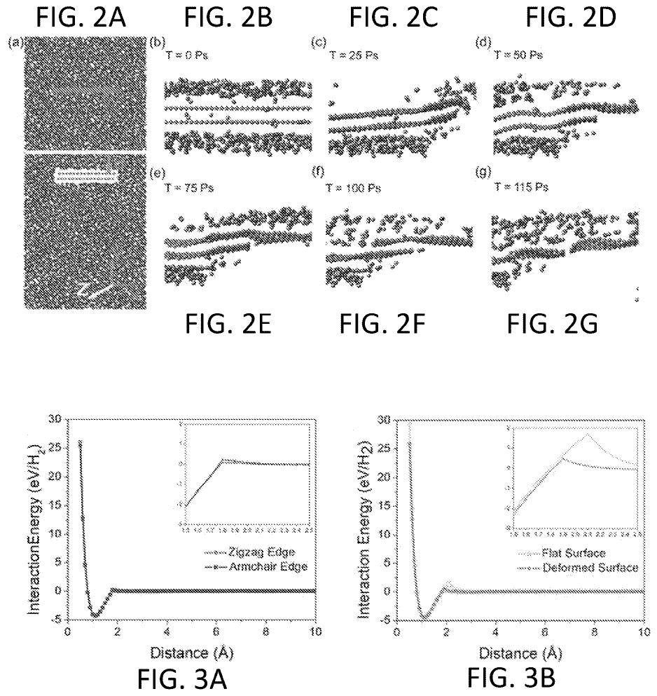

The shear mixing process was theoretically investigated via MD simulation. Initially, a two-layer graphene sheet was inserted at the center of the cell (FIG. 2A). Nose-Hoover thermostat (NVT) with a time step of 1 fs was performed to control the temperature at 300 K, where water molecules would randomly move with an average speed of 674 m/s. Then, part of the liquid was set (beyond the yellow line in FIG. 2A) to move with a certain velocity in the X direction (Vx=1,000 m/s) to create a shear flow around the graphene. Consequently, it took 115 Ps for graphene to be fully separated (FIGS. 2B-2G). The snapshots also showed that both graphene layers had to pass through multiple unit cells, and the displacement in the shear direction was ~100 nm before completing the exfoliation. Besides shear displacement, graphene also showed out-of-plane deformation during shear exfoliation. As a comparison, graphene failed to be exfoliated if the C atoms were fixed in the Y direction. Assuming the same graphene sheet was exfoliated without out-of-plane deformation (FIG. 6A), a robust interlayer force up to 4.8 eV/Å (FIG. 6B) was formed initially to resist further exfoliation. As for graphene deformed in water, the maximum force for resisting shear exfoliation was only 1 eV/Å. Therefore, out-of-plane deformation was necessary for shear exfoliation as it effectively reduced the interlayer exfoliation resistance.

The effect of hydrogen passivation was also analyzed via MD simulation. The first question is how hydrogen gas interacts with graphene. Dissociative hydrogen gas adsorption on graphene was expected, where the H—H bond in H₂ molecules would be broken, and new C—H bonds would be formed between the H atoms and graphene. In general, the adsorption could happen on the zigzag edge, armchair edge, and the surface of graphene.⁵⁰⁻⁵² An H₂ molecule was first assumed to approach the zigzag edge from the middle of the two graphene layers and then approached the armchair edge by interacting with only one graphene layer. Both cases were reported with the lowest energy adsorption energy for the adsorption at different edges, respectively.^{51, 53} As shown in FIG. 3A, the energy barrier for H₂ adsorption at the zigzag edge was almost 0, indicating that H₂ could be simultaneously adsorbed on this edge. The energy barrier for H₂ adsorption at the armchair was slightly higher (0.21 eV). Once H₂ was absorbed on the graphene surface, the energy barrier would be intensively increased to 1.8 eV. It has been reported that the convex graphene surface was more active for H₂ adsorption.⁵⁴ As graphene was deformed in water, the adsorption of H₂ on deformed graphene was analyzed by allowing a H₂ molecule to be adsorbed at the convex position of the graphene sheet, and a much lower energy barrier (0.5 eV) was obtained. Based on these results, the zigzag edge was the most favorable site for H₂ adsorption, so a model of graphene with C—H bonds at the zigzag edge was used to represent H-passivated graphene.

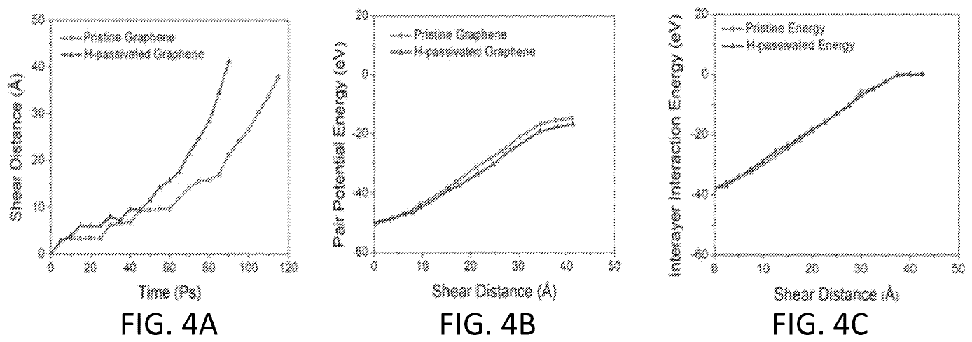

Hence, H-passivated graphene with H atoms bonded at the zigzag edge was then shear exfoliated at the same condition as pristine graphene (FIG. 9). Within the same shear flow, H-passivated graphene also showed shear displacement and out-of-plane deformation (FIG. 9), except that the exfoliation time was reduced from 110 Ps to 85 Ps (FIG. 4A), and the displacement was only ~75 nm before the full separation of graphene. For the two-layer graphene in water, the pair potential energy was calculated as:

Eₚₐᵢᵣ=Eₛₗ+Eᵢₙₜ (1)

Where Eₚₐᵢᵣ represented the total pair potential energy of graphene, Eₛₗ represented the interaction energy between graphene and water, and Eᵢₙₜ represented the interlayer interaction energy. Consequently, the exfoliation energy barrier decreased from 33 eV to 28 eV after hydrogen passivation. In the meantime, the interlayer interaction energy was almost the same for pristine and H-passivated graphene (38 eV). The lower energy barrier for exfoliation in water indicated that exfoliated graphene would form new intermolecular bonding with water. Moreover, the same interlayer interaction energy and different pair potential energy showed that hydrogen passivation only affected the interaction between graphene and water. Further comparing the equilibrium state of single-layer pristine and H-passivated graphene in water (FIG. 10), it was found that C atoms were stable at the original positions, explaining why hydrogen passivation could not affect interlayer interaction. As for graphene-water interaction, the intermolecular binding energy was increased from 4.8 eV to 7.4 eV after hydrogen passivation. The average distance between the C atoms at the zigzag edge of pristine graphene and their nearest H₂O molecules was ~3.6 Å. After hydrogen passivation, the average distance between the H atoms and the nearest H₂O atoms was ~3.5 Å. In the meantime, the average distance between the C atoms at the edge and the nearest H₂O molecules was slightly increased to 4.0 Å. After hydrogen passivation, graphene-water intermolecular bonding was formed by both C and H atoms, so the graphene-water interaction was strengthened to achieve faster shear exfoliation.

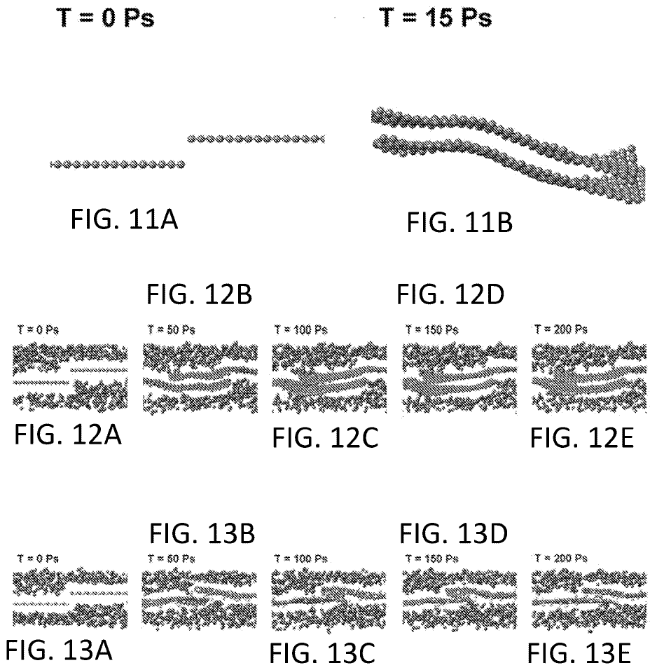

As the inverse process of shear exfoliation, agglomeration was expected to be simultaneous. This was demonstrated by two layers of isolated graphene, which were allowed to freely move at 300 K and found rapidly agglomerated in 15 Ps (FIG. 11). Once inserted into water, the graphene still showed an agglomeration tendency but much lower agglomeration speed. As shown in FIG. 12, pristine graphene was partially agglomerated with an overlap distance of ~2.5 nm at 200 Ps. The much lower agglomeration efficiency compared with isolated graphene illustrated the dispersive effect of water on graphene. For isolated graphene, the agglomeration was driven by the attractive interlayer force. Within the water, the interlayer interaction needed to break the intermolecular bonding between water and graphene so that it would be much more difficult for graphene agglomeration. Similarly, the agglomeration of H-passivated graphene was also simultaneous, while the strong interaction between water and graphene further slowed down the agglomeration (FIG. 13).

### CONCLUSION

Our study succeeded in deriving graphene from cotton via cotton graphitization, HP-coupled shear mixing and ultra-sonication. Cotton was first validated as a promising sustainable and low-cost raw material for graphene fabrication at a relatively low temperature. Then, shear exfoliation was demonstrated as an effective method to derive few-layer and single-layer graphene from cotton-derived graphite with a transfer rate of almost 100%. Moreover, hydrogen gas was verified as a feasible additive that significantly enhanced the efficiency of shear exfoliation, which was achieved by the stronger intermolecular interaction between H-passivated graphene and water. This interaction could also hinder graphene agglomeration. Therefore, the better dispersion of H-passivated graphene was also attributed to the increased intermolecular binding energy after hydrogen passivation. Above all, HP-accelerated conversion of cotton to graphene is a highly sustainable graphene fabrication method with significantly enhanced graphene productivity and lowered storage difficulty. Undoubtedly, this method presents new pathways for the graphene industry.

### Reference for Example 1

[1] Geim, A. K., Novoselov, K. S., The rise of graphene, Nanoscience and technology: a collection of reviews from nature journals, 2010, 11-19.
[2] Geim, A. K., Graphene: status and prospects, Science, 2009, 3241530-1534.
[3] Novoselov, K. S., Fal, V. I., Colombo, L., Gellert, P. R., Schwab, M. G., Kim, K., A roadmap for graphene, Nature, 2012, 490, 192-200 [4] Novoselov, K. S., Geim, A. K., Morozov, S. V., Jiang, D., Zhang, Y., Dubonos, S. V., Grigorieva, I. V., Firsov, A. A., Electric field effect in atomically thin carbon films, 2004, Science, 306, 666-669.
[5] Neto, A. C., Guinea, F., Peres, N. M., Novoselov, K. S., Geim, A. K., The electronic properties of graphene, Reviews of modern physics, 2009, 81, 109.
[6] Lee, C., Wei, X., Kysar, J. W., Hone, J., Measurement of the elastic properties and intrinsic strength of monolayer graphene, Science, 2008, 321, 385-388.
[7] Balandin, A. A., Ghosh, S., Bao, W., Calizo, I., Teweldebrhan, D., Miao, F., Lau, C. N., Superior thermal conductivity of single-layer graphene, Nano letters, 2008, 8, 902-907.
[8] Stankovich, S., Dikin, D. A., Dommett, G. H., Kohlhaas, K. M., Zimney, E. J., Stach, E. A., Piner, R. D., Nguyen, S. T., Ruoff, R. S., Graphene-based composite materials. Nature, 2006, 442, 282-286
[9] Zhu, Y., Murali, S., Cai, W., Li, X., Suk, J. W., Potts, J. R., Ruoff, R. S., Graphene and graphene oxide: synthesis, properties, and applications. Advanced materials, 2010, 22, 3906-3924.
[10] Reina, A., Jia, X., Ho, J., Nezich, D., Son, H., Bulovic, V., Dresselhaus, M. S., Kong, J., Large area, few-layer graphene films on arbitrary substrates by chemical vapor deposition. Nano Letters, 2009, 9, 30-35.
[11] Marcano, D. C., Kosynkin, D. V., Berlin, J. M., Sinitskii, A., Sun, Z., Slesarev, A., Alemany, L. B., Lu, W., Tour, J. M., Improved synthesis of graphene oxide. ACS Nano, 2010, 4, 4806-4814.
[12] Xu, Y., Cao, H., Xue, Y., Li, B., Cai, W., Liquid-phase exfoliation of graphene: an overview on exfoliation media, techniques, and challenges. Nanomaterials, 2018, 8, 942
[13] Munoz, R., Gómez-Aleixandre, C., Review of CVD synthesis of graphene. Chemical Vapor Deposition, 2013. 19, 297-322.
[14] Wang, L., Zhang, X., Chan, H. L., Yan, F., Ding, F., Formation and healing of vacancies in graphene chemical vapor deposition (CVD) growth. Journal of the American Chemical Society, 2013, 135, 4476-4482.
[15] Cabrero-Vilatela, A., Weatherup, R. S., Braeuninger-Weimer, P., Caneva, S., Hofmann, S., Towards a general growth model for graphene CVD on transition metal catalysts. Nanoscale, 2016, 8, 2149-2158.
[16] Zhang, Y. L., Zhang, L., Zhou, C., Review of chemical vapor deposition of graphene and related applications. Accounts of chemical research, 2013, 46, 2329-2339.
[17] Zhang, Y., Song, N., He, J., Chen, R., Li, X., Lithiation-aided conversion of end-of-life lithium-ion battery anodes to high-quality graphene and graphene oxide. Nano letters, 2018, 19, 512-519.
[18] Hossain, M. Z., Johns, J. E., Bevan, K. H., Karmel, H. J., Liang, Y. T., Yoshimoto, S., Mukai, K., Koitaya, T., Yoshinobu, J., Kawai, M., Lear, A. M., Chemically homogeneous and thermally reversible oxidation of epitaxial graphene. Nature chemistry, 2012, 4, 305-309.
[19] Chen, J., Li, Y., Huang, L., Li, C., Shi, G., High-yield preparation of graphene oxide from small graphite flakes via an improved Hummers method with a simple purification process. Carbon, 2015. 81, 826-834.
[20]. Cao, N., Zhang, Y., Study of reduced graphene oxide preparation by Hummers' method and related characterization. Journal of Nanomaterials, 2015, 2015.
[21]. Paton, K. R., Varrla, E., Backes, C., Smith, R. J., Khan, U., O'Neill, A., Boland, C., Lotya, M., Istrate, O. M., King, P., Higgins, T., Scalable production of large quantities of defect-free few-layer graphene by shear exfoliation in liquids. Nature materials, 2014, 13, 624-630.
[22] Yi, M., Shen, Z., A review on mechanical exfoliation for the scalable production of graphene. Journal of Materials Chemistry A, 2015, 3, 11700-11715.
[23] Dong, L., Chen, Z., Zhao, X., Ma, J., Lin, S., Li, M., Bao, Y., Chu, L., Leng, K., Lu, H. and Loh, K. P., A non-dispersion strategy for large-scale production of ultra-high concentration graphene slurries in water. Nature communications, 2018, 9, 1-8.
[24] Atif, R. Inam, F., Reasons and remedies for the agglomeration of multilayered graphene and carbon nanotubes in polymers. Beilstein journal of nanotechnology, 2016, 7, 1174-1196.
[25] Liu, B., Yang, M., Yang, D., Chen, H., Li, H., Graphene-like porous carbon nanosheets for ultra-high rate performance supercapacitors and efficient oxygen reduction electrocatalysts. Journal of Power Sources, 2020, 456, 227999.
[26] Mondal, D., Sharma, M., Wang, C. H., Lin, Y. C., Huang, H. C., Saha, A., Nataraj, S. K., Prasad, K., Deep eutectic solvent promoted one step sustainable conversion of fresh seaweed biomass to functionalized graphene as a potential electrocatalyst. Green Chemistry, 2016, 18, 2819-2826.
[27] Lu, S. Y., Jin, M., Zhang, Y., Niu, Y. B., Gao, J. C., Li, C. M., Chemically exfoliating biomass into a graphene-like porous active carbon with rational pore structure, good conductivity, and large surface area for high-performance supercapacitors. Advanced Energy Materials, 2018, 8, 1702545.
[28] Zhou, H., Zhang, J., Amiinu, I. S., Zhang, C., Liu, X., Tu, W., Pan, M., Mu, S., Transforming waste biomass with an intrinsically porous network structure into porous nitrogen-doped graphene for highly efficient oxygen reduction. Physical Chemistry Chemical Physics, 2016, 18, 10392-10399.
[29] Mohanraj, J., Durgalakshmi, D., Rakkesh, R. A., Balakumar, S., Rajendran, S., Karimi-Maleh, H., Facile synthesis of paper based graphene electrodes for point of care devices: A double stranded DNA (dsDNA) biosensor. Journal of Colloid and Interface Science, 2020, 566, 463-472.
[30] Shams, S. S., Zhang, L. S., Hu, R., Zhang, R., Zhu, J., Synthesis of graphene from biomass: a green chemistry approach. Materials Letters, 2015, 161, 476-479.
[31] Chen, F., Yang, J., Bai, T., Long, B., Zhou, X., Facile synthesis of few-layer graphene from biomass waste and its application in lithium ion batteries. Journal of Electroanalytical Chemistry, 2016. 768, 18-26.
[32] Lu, S. Y., Jin, M., Zhang, Y., Niu, Y. B., Gao, J. C., Li, C. M., Chemically exfoliating biomass into a graphene-like porous active carbon with rational pore structure, good conductivity, and large surface area for high-performance supercapacitors. Advanced Energy Materials, 2018, 8, 1702545.
[33] Wang, Z., Yu, J., Zhang, X., Li, N., Liu, B., Li, Y., Wang, Y., Wang, W., Li, Y., Zhang, L., Dissanayake, S., Large-scale and controllable synthesis of graphene quantum dots from rice husk biomass: a comprehensive utilization strategy. ACS applied materials & interfaces, 2016, 8, 1434-1439.
[34] Gao, Z., Zhang, Y., Song, N., Li, X., Towards flexible lithium-sulfur battery from natural cotton textile. Electrochimica Acta, 2017, 246, 507-516.
[35] Gao, Z., Bumgardner, C., Song, N., Zhang, Y., Li, J., Li, X., Cotton-textile-enabled flexible self-sustaining power packs via roll-to-roll fabrication. Nature communications, 2016, 7, 1-12.
[36] Gao, Z., Song, N., Zhang, Y., Li, X., Cotton-textile-enabled, flexible lithium-ion batteries with enhanced capacity and extended lifespan, Nano letters, 2015, 15, 8194-8203.
[37] Gopalakrishnan, A., Kong, C. Y., Badhulika, S., Scalable, large-area synthesis of heteroatom-doped few-layer graphene-like microporous carbon nanosheets from biomass for high-capacitance supercapacitors. New Journal of Chemistry, 2019, 43, 1186-1194.
[38] Purkait, T., Singh, G., Singh, M., Kumar, D., Dey, R. S., Large area few-layer graphene with scalable preparation from waste biomass for high-performance supercapacitor. Scientific reports, 2017, 7, 1-14
[39] Yang, Y., Rigdon, W., Huang, X., Li, X., Enhancing graphene reinforcing potential in composites by hydrogen passivation induced dispersion. Scientific reports, 2013, 3, 1-7.
[40] Thompson, A. P., Aktulga, H. M., Berger, R., Bolintineanu, D. S., Brown, W. M., Crozier, P. S., in't Veld, P. J., Kohlmeyer, A., Moore, S. G., Nguyen, T. D., Shan, R., LAMMPS-a flexible simulation tool for particle-based materials modeling at the atomic, meso, and continuum scales. Computer Physics Communications, 2022, 271, 108171. https://www.lammps.org
[41] Humphrey, W., Dalke, A., Schulten, K., VMD: visual molecular dynamics. Journal of molecular graphics, 1996, 14, 33-38. http://www.ks.uiuc.edu/Research/vmd/
[42] Kim, J., Lee, T. R., Prediction of the molecular-level critical shear rates for the liquid exfoliation of graphene layers. Journal of Applied Physics, 2021, 130, 215105.
[43] Abascal, J. L., Vega, C., A general purpose model for the condensed phases of water: TIP4P/2005. The Journal of chemical physics, 2005, 123, 234505.
[44] Wu, Y., Aluru, N. R., Graphitic carbon-water nonbonded interaction parameters. The Journal of Physical Chemistry B, 2013, 117, 8802-8813.
[45] Barreto, P. R., Albernaz, A. F., Capobianco, A., Palazzetti, F., Lombardi, A., Grossi, G. and Aquilanti, V., Potential energy surfaces for interactions of H2O with H2, N2 and O2: a hyperspherical harmonics representation, and a minimal model for the H2O-rare-gas-atom systems. Computational and Theoretical Chemistry, 2012, 990, 53-61.
[46] Sun, D. Y., Liu, J. W., Gong, X. G. and Liu, Z. F., Empirical potential for the interaction between molecular hydrogen and graphite. Physical Review B, 2007, 75, 075424.
[47] Haigler, C. H., Betancur, L., Stiff, M. R., Tuttle, J. R., Cotton fiber: a powerful single-cell model for cell wall and cellulose research. Frontiers in plant science, 2012, 3, 104.
[48] Ferrari, A. C., Meyer, J. C., Scardaci, V., Casiraghi, C., Lazzeri, M., Mauri, F., Piscanec, S., Jiang, D., Novoselov, K. S., Roth, S., Geim, A. K., Raman spectrum of graphene and graphene layers. Physical review letters, 2006, 97, 187401.
[49] Brushwood, D. E., Perkins, H. H., Determining the metal content of cotton. Textile Chemist and Colorist, 1994, 26, 32-35.
[50] Sha, X. and Jackson, B., 2004. The location of adsorbed hydrogen in graphite nanostructures. Journal of the American Chemical Society, 126 (40), pp. 13095-13099.
[51] Diño, W. A., Miura, Y., Nakanishi, H., Kasai, H., Sugimoto, T. and Kondo, T., H₂ dissociative adsorption at the armchair edges of graphite. Solid state communications, 2004, 132, 713-718.
[52] Miura, Y., Kasai, H., Dino, W., Nakanishi, H. and Sugimoto, T., First principles studies for the dissociative adsorption of H 2 on graphene. Journal of Applied Physics, 2003. 93, 3395-3400.
[53] Diño, W. A., Nakanishi, H., Kasai, H., Sugimoto, T. and Kondo, T., H₂ dissociative adsorption at the zigzag edges of graphite. e-Journal of Surface Science and Nanotechnology, 2004, 2, 77-80.
[54] Goler, S., Coletti, C., Tozzini, V., Piazza, V., Mashoff, T., Beltram, F., Pellegrini, V. and Heun, S., Influence of graphene curvature on hydrogen adsorption: toward hydrogen storage devices. The Journal of Physical Chemistry C, 2013. 117, 11506-11513.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A method of making graphene, comprising:
providing a biomass material, wherein the biomass material comprising cellulose-based fibers;
exposing the biomass material to an activating agent to form a treated biomass material;
carbonizing the treated biomass material in a furnace at a temperature of about 400 to 1200° C. for about 0.5 to 4 hours to form carbonized biomass material;
graphitizing, after carbonizing, the carbonized biomass material in the furnace at about 1000 to 3000° C. for about 0.5 to 3 hours to form graphite;
shear mixing the graphite with optional hydrogen passivation of the graphite; and
ultrasonication, after shear mixing, of the graphite, with optional hydrogen passivation of the graphite, to form graphene.

2. The method of claim 1, further comprising drying the treated biomass material for about 2 to 8 hours in an oven at a temperature of about 40 to 80° C.

3. The method of claim 1, wherein carbonizing is conducted with the furnace at a temperature of about 725 to 775° C.

4. The method of claim 1, wherein graphitizing is conducted with the furnace at a temperature of about 1150 to 1250° C.

5. The method of claim 1, wherein shear mixing the graphite includes shear mixing with concurrent hydrogen passivation of the graphite, optionally the shear mixing with concurrent hydrogen passivation is performed for about 0.5 to 10 hours.

6. The method of claim 1, wherein ultrasonication includes ultrasonication with concurrent hydrogen passivation of the graphite to form graphene, optionally the ultrasonication with concurrent hydrogen passivation is performed for about 0.5 to 3 hours.

7. The method of claim 1, wherein shear mixing the graphite includes shear mixing with concurrent hydrogen passivation of the graphite, wherein ultrasonication includes ultrasonication with concurrent hydrogen passivation of the graphite to form graphene, wherein the shear mixing with concurrent hydrogen passivation and the ultrasonication with concurrent hydrogen passivation together are performed for about 0.5 to 12 hours.

8. The method of claim 1, wherein the graphene comprises a single layer graphene, a bilayer graphene, a three layer graphene, or a combination of these.

9. The method of claim 8, wherein the single layer graphene sheet has a thickness of about 0.30 and 0.40 nm.

10. The method of claim 1, wherein the graphene has a specific surface area of about 1100 to 1400 m²·g⁻¹.

11. The method of claim 1, wherein the biomass material is a cotton material.

12. The method of claim 11, wherein the cotton material is waste cotton, recycled cotton, cotton straw, or a combination of these.

13. The method of claim 1, wherein the activating agent is KOH, NaOH, H₂SO₄, H₃PO₄, ZnCl₂, or FeCl₃.

14. A method of making graphene, comprising:
providing a biomass material, wherein the biomass material comprising cellulose-based fibers;
exposing the biomass material to an activating agent to form a treated biomass material, wherein the activating agent disrupts interlayer interactions within the biomass material;
carbonizing the treated biomass material in a furnace at a temperature of about 500 to 1000° C. for about 0.5 to 4 hours to form carbonized biomass material;
graphitizing, after carbonizing, the carbonized biomass material in the furnace at about 1100 to 2200° C. for about 0.5 to 3 hours to form graphite;
shear mixing the graphite with concurrent hydrogen passivation of the graphite; and
ultrasonication of the graphite, with concurrent hydrogen passivation of the graphite, to form graphene.

15. The method of claim 14, further comprising drying the treated biomass material for about 2 to 8 hours in an oven at a temperature of about 50 to 70° C.

16. The method of claim 14, wherein carbonizing is conducted with the furnace at a temperature of about 725 to 775° C., wherein graphitizing is conducted with the furnace at a temperature of about 1150 to 1250° C.

17-24. (canceled)

25. A method of making graphene, comprising:
providing a cotton material, wherein the cotton material comprising cellulose-based fibers;
exposing the cotton material to an activating agent to form a treated cotton material;
carbonizing the treated cotton material in a furnace at a temperature of about 600 to 900° C. for about 0.5 to 4 hours to form carbonized cotton material;
graphitizing, after carbonizing, the carbonized cotton material in the furnace at about 1000 to 1200° C. for about 1 to 3 hours to form graphite;
shear mixing the graphite with concurrent hydrogen passivation of the graphite; and
ultrasonication of the graphite with concurrent hydrogen passivation of the graphite, to form graphene, wherein a total time of shear mixing and ultrasonication is about 1 to 12 hours.

26. The method of claim 25, further comprising drying the treated biomass material for about 2 to 8 hours in an oven at a temperature of about 40 to 80° C.

27. The method of claim 25, wherein carbonizing is conducted with the furnace at a temperature of about 725 to 775° C., wherein graphitizing is conducted with the furnace at a temperature of about 1150 to 1250° C.

28-35. (canceled)
